(19) United States
(12) Patent Application Publication
(10) Pub. No.: US 2026/0167777 A1
(43) Pub. Date: Jun. 18, 2026

(54) CURABLE SILICONE COMPOSITION

(71) Applicant: MOMENTIVE PERFORMANCE MATERIALS INC., Niskayuna, NY (US)

(72) Inventors: Hao SHEN, Verona, NJ (US); Amith ANIL, Bangalore (IN); Alitta Anna CHERIYAN, Bangalore (IN); Kathryn ARKIN, Chapin, SC (US); Anne DUSSAUD, Croton on Hudson, NY (US); Michael YOUNGBERG, Westwood, NJ (US); Vinu Krishnan APPUKUTTAN, Bangalore (IN)

(21) Appl. No.: 19/424,799

(22) Filed: Dec. 18, 2025

(30) Foreign Application Priority Data
Dec. 18, 2024 (IN) 202411100477

(51) Int. Cl. C08G 77/458; C08G 77/08; C08K 5/544; C09D 5/00; C09D 7/63; C09D 7/80; C09D 183/10; C09J 183/10

(52) U.S. Cl. CPC C08G 77/458; C08G 77/08; C08K 5/544; C09D 5/002; C09D 7/63; C09D 183/10; C09J 183/10; C08G 2150/00; C08G 2170/00; C08G 2190/00; C09D 7/80

(57) ABSTRACT

A moisture curable composition comprises a silylated polymer resin and a reactive diluent. The reactive diluent comprises a high carbon content and includes alkoxy groups having long carbon chains.

### CROSS-REFERENCE TO RELATED APPLICATIONS

This application claim priority to and the benefit of India Provisional Application No. 202411100477, filed on Dec. 18, 2024, titled “CURABLE SILICONE COMPOSITION,” the entire disclosure of which is incorporated herein by reference in its entirety.

### FIELD OF INVENTION

The present invention relates to moisture curable resin compositions. More particularly, the present invention relates to moisture curable resin compositions comprising silylated polymers and reactive diluents; coating, adhesive, and/or sealant compositions comprising such moisture curable resin compositions; and cured materials, e.g., coatings, adhesive, and/or sealants formed therefrom.

### BACKGROUND

Hydrolysable silane-terminated polymers are commonly used in products such as adhesives, sealants, and coatings. Cured products made from hydrolysable silane-terminated polymers tend to have low modulus and low tensile strength. Silanes are often employed as reactive diluents to attempt to increase the hydrophobicity of the cured elastomer. In particular, alkyl methoxy or alkyl ethoxy silanes with C8 to C16 alkyl groups have been used in the past in such curable compositions. These reactive diluents are typically used at relatively high concentrations, e.g., 5 wt. % to 30 wt. %, and, as such, the reactive diluent may have a significant effect on the mechanical properties of the cured material.

While providing hydrophobicity to the composition, these longer chain alkyl alkoxy silanes may increase the crosslinking density such that the cured material has a relatively low elongation at break (i.e., decreased flexibility). The most common alkyl alkoxy silanes such as octyl trimethoxy silane or octyl triethoxy silane are also volatile materials and considered 100% VOC under ASTM D2369. Thus, before full curing of the curable composition, non-reacted volatile silanes can evaporate and have undesirable environmental effects. Other long chain alkyl trimethoxy silanes such as hexadecyl trimethoxy silane or octadecyl trimethoxy silane are less volatile than octyl trimethoxy silane, but produce cured materials having poor mechanical properties particularly when used with polymer resins that are terminated with trimethoxy silanes. Accordingly, there is a need for curable compositions comprising silylated polymers and reactive diluents having low VOC content and exhibiting good mechanical properties.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is a curable composition comprising a silylated polymer and a reactive diluent, where the reactive diluent is an alkyl alkoxy silane comprising both long chain alkyl groups and long chain alkoxy groups. The present reactive diluents have been found to be low VOC materials that when used as a reactive diluent in a curable composition with a silylated polymer resin provide a cured material having good mechanical properties including, for example, tensile strength, elongation, and modulus.

In one aspect, provided is a curable composition comprising:
a silylated polymer resin;
a reactive diluent selected from a compound of the formula:

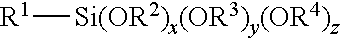

where R¹ is selected from a hydrocarbon group having 8 to 40 carbon atoms or a heterocarbon group having 8 to 40 carbon atoms;
R² is selected from a C1 to C4 hydrocarbon;
R³ and R⁴ are independently selected from a C8 to C40 hydrocarbon and a heterocarbon having 8 to 40 carbons, wherein the heterocarbon comprises one or more hetero atoms selected from oxygen, silicon, nitrogen, and sulfur; with the proviso that when R¹ is a hydrocarbon group having 8 to 40 carbon atoms and R³ or R⁴ is a hydrocarbon then at least one of R³ or R⁴ comprises 12 or more carbon atoms;
x is 0 to less than 3;
y is 0 to 3;
z is 0 to 3;
x+y+z is 3; and
y+z is greater than 0; and
a catalyst.

In one embodiment, R¹ is a C8 to C40 hydrocarbon.

In one embodiment in accordance with any previous embodiment, R¹ is selected from a linear, branched, or cyclic containing C8-C40 alkyl, or a C8-C40 aromatic-containing group.

In one embodiment, R¹ is selected from the heterocarbon group having 8 to 40 carbon atoms, and the heterocarbon having 8 to 40 carbon atoms is of the formula:

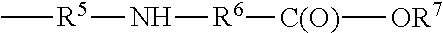

where R⁵ is a divalent C2-C8 hydrocarbon;
R⁶ is a divalent C2-C8 hydrocarbon; and
R⁷ is a monovalent C3-C25 hydrocarbon.

In one embodiment, R⁵ and R⁶ are independently selected from a divalent C2-C8 linear, branched, or cyclic group.

In one embodiment, in accordance with any previous embodiment, R⁷ is selected from a linear, branched, or cyclic-containing C3-C25 alkyl.

In one embodiment, in accordance with any previous embodiment, R² is selected from methyl, ethyl, propyl, isopropyl, butyl, isobutyl, or tert-butyl.

In one embodiment, in accordance with any previous embodiment, R³ and R⁴ are independently selected from a linear, branched, or cyclic, substituted or unsubstituted C8-C40 alkyl or a linear, branched, or cyclic aromatic substituted C8-C40 aralkyl.

In one embodiment, R³ and R⁴ are independently selected from a linear, branched, or cyclic C12-C40 alkyl substituted with aromatic group, wherein the C12-C40 alkyl is optionally containing alkenyl groups.

In one embodiment, R³ and R⁴ are derived from Cardanol.

In one embodiment in accordance with any previous embodiment, x is 0.1 to 2.5, and y and z are independently 0 to 3 with the proviso that y+z is greater than 0.

In one embodiment in accordance with any previous embodiment, z is from 0 to 3, and y is 0.1 to 2.9.

In one embodiment in accordance with any previous embodiment, x is 0.1 to 2.5, z is 0, and y is 0.5 to 2.9.

In one embodiment in accordance with any previous embodiment, z is 0; R¹ is a C8-C40 alkyl; R² is a C1-C4 alkyl; R³ is a C10-C40 alkyl; x is 0 to less than 3, y is greater than 0 to 3; and x+y is equal to 3.

In one embodiment, R² is methyl and R³ is a C12-C14 alkyl.

In one embodiment, (i) x is 0 and y is 3, (ii) x is 0.5 and y is 2.5, (iii) x is 1 and y is 2, (iv) x is 1.85 and y is 1.15, (v) x is 2 and y is 1, or (vi) x is 2.25 and y is 0.75.

In one embodiment in accordance with any previous embodiment, z is 0; R¹ is of the formula: —R⁵—NH—R⁶—C(O)—OR⁷, where R⁵ is a divalent C2-C8 hydrocarbon, R⁶ is a divalent C2-C8 hydrocarbon, and R⁷ is a monovalent C3-C25 hydrocarbon; R² is a C1-C4 alkyl; R³ is a C8-C40 alkyl; x is 0 to less than 3, y is greater than 0 to 3; and x+y is equal to 3.

In one embodiment in accordance with any previous embodiment, R² is methyl and R³ is a C8-C14 alkyl.

In one embodiment in accordance with any previous embodiment, (i) x is 0.5 and y is 2.5, (ii) x is 1 and y is 2, (iii) x is 1.85 and y is 1.15, (iii) x is 2 and y is 1, or (iv) x is 2.25 and y is 0.75.

In one embodiment in accordance with any previous embodiment, z is 0; R¹ is a C8-C40 alkyl; R² is a C1-C4 alkyl; R³ is a C12-C40 alkylaryl; x is 0 to 3, y is greater than 0 to 3; and x+y is equal to 3.

In one embodiment in accordance with any previous embodiment, R² is methyl and R³ is a C16-C22 alkylaryl.

In one embodiment in accordance with any previous embodiment, the alkylaryl comprises at least one unsaturated carbon-carbon bond.

In one embodiment in accordance with any previous embodiment, (i) x is 0 and y is 3, (ii) x is 1 and y is 2, (iii) x is 1.85 and y is 1.15, (iii) x is 2 and y is 1, or (iv) x is 2.25 and y is 0.75.

In one embodiment in accordance with any previous embodiment, the reactive diluent is present in an amount of from about 1 wt. % to about 25 wt. % based on the weight of the curable composition.

In one embodiment in accordance with any previous embodiment, the silylated resin is selected from a silylated polyol, a silylated polyether, a silylated polyurethane resin, and a silane-containing copolymer obtained from the copolymerization of one or more ethylenically unsaturated silanes.

In one embodiment in accordance with any previous embodiment, the silylated resin is selected from a silylated polyurethane resin.

In one embodiment, in accordance with any previous embodiment, the silylated resin comprises a hydrolysable group comprising a trialkoxy silane.

In one embodiment, in accordance with any previous embodiment, the silylated resin is present in an amount of from about 1% by weight to about 70% by weight of the composition.

In one embodiment, in accordance with any previous embodiment, the catalyst is selected from a tin catalyst.

In one embodiment, in accordance with any previous embodiment, the catalyst is present in an amount of from about 0.01 weight percent to about 5 weight percent based on the total weight of the composition.

In one embodiment, in accordance with any previous embodiment, the curable composition comprises an adhesion promoter.

In one embodiment, in accordance with any previous embodiment, the adhesion promoter is selected from an aminosilane.

In one embodiment, in accordance with any previous embodiment, the adhesion promoter is present in an amount of from about 0.1 weight percent to about 20 weight percent based on the total weight of the composition.

In one embodiment in accordance with any previous embodiment, the curable composition comprises a non-silylated silicone.

In one embodiment in accordance with any previous embodiment, the non-silylated silicone is selected from a hydroxy functional silicone, an epoxy functional silicone, or combination thereof.

In one aspect, provided is a cured material formed from the curable composition of any of the previous aspects or embodiments.

In another aspect, provided is a coating composition comprising the curable composition of any of the previous aspects or embodiments.

In one embodiment, the coating is a sealant, an adhesive, or a primer.

In one embodiment, the cured material or coating composition of any of the previous aspects or embodiments has an elongation of about 90% or greater.

In one embodiment, the cured material or coating composition of any of the previous aspects or embodiments has an elongation of about 90% to about 300%.

In yet another aspect, provided is an article comprising a substrate and a curable composition of any of the previous aspects or embodiments disposed on a surface of the substrate.

In one embodiment, the substrate is selected from concrete, wood, plastic, metal, glass fiber, fiber fabric, or a mixture of two or more thereof.

In one embodiment in accordance with any previous embodiment, the curable composition is cured to form a coating.

In one embodiment in accordance with any previous embodiment, the substrate comprising the curable composition is adhered to a second substrate through the curable composition.

In still a further aspect, provided is a method of forming the coating composition of any of the previous aspects or embodiments comprising mixing the silylated polymer resin, reactive diluent, and catalyst.

In still another aspect, provided is a method of forming a cured material comprising exposing the curable composition of any of the previous aspects or embodiments to moisture.

The following description discloses various illustrative aspects. Some improvements and novel aspects may be expressly identified, while others may be apparent from the description and drawings.

### DETAILED DESCRIPTION

Reference will now be made to exemplary embodiments, examples of which are illustrated in the accompanying description, embodiments, and examples. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It will be appreciated that any numerical range recited herein includes all sub-ranges within that range. Additionally, any numerical values including, but not limited to, endpoints of any ranges may be used to form new and non-specified ranges.

Any compound, material, or substance that is expressly or implicitly disclosed in the specification and/or recited in a claim as belonging to a group of structurally, compositionally, and/or functionally related compounds, materials, or substances includes individual representatives of the group and all combinations thereof.

The term “parts per hundred resin,” which may be designated “PHR”, is a unit of measurement for the amount of a component (e.g., an additive or the like) in a resin or plastic. Parts per hundred resin is expressed as or refers to the amount of a component as grams (of the component) per 100 grams of resin.

The term “hydrocarbon” when used in the context of a substituent group of a compound refers to a hydrocarbon from which one or more hydrogen atoms has been removed and is inclusive of alkyl, alkenyl, alkynyl, cyclic alkyl, cyclic alkenyl, cyclic alkynyl, aryl, aralkyl, alkaryl and arenyl and may contain heteroatoms.

The term “alkyl” means any monovalent, saturated straight, branched, or cyclic hydrocarbon group; the term “alkenyl” means any monovalent straight, branched, or cyclic hydrocarbon group containing one or more carbon-carbon double bonds where the site of attachment of the group can be either at a carbon-carbon double bond or elsewhere therein; and, the term “alkynyl” means any monovalent straight, branched, or cyclic hydrocarbon group containing one or more carbon-carbon triple bonds and, optionally, one or more carbon-carbon double bonds, where the site of attachment of the group can be either at a carbon-carbon triple bond, a carbon-carbon double bond or elsewhere therein. Examples of alkyls include, but are not limited to, methyl, ethyl, propyl and isobutyl. Examples of alkenyls include, but are not limited to, vinyl, propenyl, allyl, methallyl, ethylidenyl norbornane, ethylidene norbornyl, ethylidenyl norbornene and ethylidene norbornenyl. Examples of alkynyls include, but are not limited to, acetylenyl, propargyl and methylacetylenyl.

The term “cyclic alkyl,” “cyclic alkenyl,” and “cyclic alkynyl” include bicyclic, tricyclic, and higher cyclic structures as well as the aforementioned cyclic structures further substituted with alkyl, alkenyl, and/or alkynyl groups. Examples include, but are not limited to, norbornyl, norbornenyl, ethylnorbornyl, ethylnorbornenyl, cyclohexyl, ethylcyclohexyl, ethylcyclohexenyl, cyclohexylcyclohexyl and cyclododecatrienyl.

The term “aryl” means any monovalent aromatic hydrocarbon group; the term “aralkyl” means any alkyl group (as defined herein) in which one or more hydrogen atoms have been substituted by the same number of like and/or different aryl (as defined herein) groups; and, the term “alkaryl” means any aryl group (as defined herein) in which one or more hydrogen atoms of an aromatic group have been substituted by the same number of like and/or different hydrocarbon groups, e.g., alkyl groups or unsaturated hydrocarbons (as defined herein). Examples of aryls include, but are not limited to, phenyl and naphthalenyl. Examples of aralkyls include, but are not limited to, benzyl and phenethyl. Examples of alkaryl include, but are not limited to, tolyl and xylyl.

The term “heteroatom” means any of the Group 13-17 elements except carbon. Examples of heteroatoms include, but are not limited to, oxygen, nitrogen, silicon, sulfur, phosphorus, fluorine, chlorine, bromine and iodine.

The terms “polymer” and “resin” or “polymer resin” as used herein are used interchangeably with one another.

The term “heterocarbon group” as used herein refers to a group having from 8 to 40 carbon atoms that comprises one or more heteroatoms selected from oxygen, nitrogen, silicon, or sulfur disposed within a carbon chain and/or pendant to a carbon atom.

Provided is a curable composition comprising a moisture-curable silylated polymer and a reactive diluent, where the reactive diluent is an alkyl alkoxy silane comprising both long chain alkyl groups and long chain alkoxy groups. The present reactive diluents have been found to be low VOC materials that when used as a reactive diluent in a curable composition with a silylated polymer resin provide a cured material having good mechanical properties including, for example, tensile strength, elongation, and modulus.

The moisture-curable polymer is not particularly limited and can be selected as desired for a particular purpose or intended application. The moisture-curable polymer is a polymer that, upon exposure to moisture, undergoes hydrolysis and subsequent condensation to provide a resin having properties suitable for a particular purpose or intended application. Generally, moisture-curable polymers are suitable for forming a material that is suitable for use as an adhesive, sealant, coating, and the like.

The base structure, repeating unit, or backbone of the polymer is generally not limited and can be selected as desired for a particular purpose or intended application. In one embodiment, the polymer is selected from a polyepoxide, a polyolefin, a polyvinylchloride, a polyester, a polyurethane, a polyamide, a polyfluoroalkene, a polyether, a polyacrylic, a polymethacrylic, and the like that comprises a hydrolysable functional group that renders the polymer reactive upon exposure to moisture.

In one embodiment, the moisture-curable polymer is a polymer resin comprising a hydrolysable silyl group. These may also be referred to as silylated polymers. Examples of suitable silylated polymers include, but are not limited to, silylated polyols, silylated polyethers, silylated polyurethane resins, silylated polyacrylates, silylated polycarbonates and silane-containing copolymers derived from the copolymerization of one or more ethylenically unsaturated silanes such as vinylsilanes, allylsilanes and methallylsilanes, acryloxyalkylsilane, methacryloxyalkylsilanes and one or more other ethylenically unsaturated monomers such as olefinic hydrocarbons, acrylic acid, methacrylic acid, acrylate ester, methacrylate ester, ethylenically unsaturated dicarboxylic acids and/or their anhydrides, oligomers and/or polymers possessing ethylenic unsaturation, and the like. In one embodiment, the moisture-curable polymer is selected from a silylated polyurethane resin (SPUR). The moisture-curable polyurethane is not particularly limited and can be selected as desired for a particular purpose or intended application.

For silylated resins, the resin can be formed by reacting an appropriate silane functional material with a precursor resin. Such suitable precursor resins will be generally known or determinable by those skilled in the art. In one embodiment, suitable precursor resins include (i) polyether polyols, (ii) polyester polyols, (iii) hydroxyl-terminated polybutadienes, hydroxyl terminated polycarbonates, hydroxyl terminated polyacrylates, naturally derived polyols (polyols derived from vegetable oils, castor oils, derivatives of lignins, lignin based polyols) (iv) hydroxyl-terminated and isocyanate-terminated polyurethane (PUR) prepolymers derived from any of the foregoing, (v) isocyanate-terminated and amine-terminated polyurethane-polyurea (poly(urethane-urea) or polyurethaneurea) prepolymers and polyurea prepolymers derived from polyamines, and (vi) olefinically unsaturated polymers that are capable of undergoing hydrosilation with hydridrosilanes, e.g., polyolefins and polyethers possessing terminal olefinic unsaturation. The resin can be obtained by silylating these and similar precursor resins in any now known or later discovered manner. Some current existing processes for obtaining silylated resins include, e.g., silylating a hydroxyl-terminated resin by reaction with an isocyanatosilane, silylating an isocyanate-terminated resin with a silane possessing functionality that is reactive for isocyanate such as mercapto or amino functionality, and silylating an olefinically unsaturated resin by reaction with a hydridosilane (hydrosilane) under hydrosilation reaction conditions.

In one embodiment, the moisture-curable resin is a silylated polyurethane (SPUR) resin such as, but not limited to, those described in U.S. Pat. No. 5,990,257 and can be made by any of the methods described therein, the entire contents of which are incorporated herein by reference in their entirety.

In embodiments, the silylated polyurethane resin comprises a silane-terminated polymer having an end group of the formula:

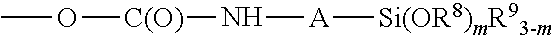

where
wherein R⁸ and R⁹ are each independently selected from a linear or branched, unsubstituted or halogen-substituted alkyl group having 1 to 5 carbon atoms;
m is 1, 2, or 3;
A is a linear or branched alkylene group having 1 to 10 carbon atoms, and in embodiments is selected from a propylene or methylene group.

Isocyanate-terminated PUR prepolymers can be obtained by reacting one or more polyols, advantageously, diols, with one or more polyisocyanates, advantageously, diisocyanates, in such proportions that the resulting prepolymers will be terminated with isocyanate. In the case of reacting a diol with a diisocyanate, a molar excess of diisocyanate will be employed.

Included among the polyols that can be utilized for the preparation of the isocyanate-terminated PUR prepolymer are polyether polyols, polyester polyols such as the hydroxyl-terminated polycaprolactones, polyetherester polyols such as those obtained from the reaction of polyether polyol with e-caprolactone, polyesterether polyols such as those obtained from the reaction of hydroxyl-terminated polycaprolactones with one or more alkylene oxides such as ethylene oxide and propylene oxide, hydroxyl-terminated polybutadienes, and the like.

Specific suitable polyols that can be utilized for the preparation of the isocyanate-terminated PUR prepolymer include the poly(oxyalkylene)ether diols (i.e., polyether diols), in particular, the poly(oxyethylene)ether diols, the poly(oxypropylene)ether diols and the poly(oxyethylene-oxypropylene)ether diols, poly(oxyalkylene)ether triols, poly(tetramethylene)ether glycols, polyacetals, polyhydroxy polyacrylates, polyhydroxy polyester amides, polyhydroxy polythioethers, polycaprolactone diols and triols, and the like. In one embodiment of the present invention, the polyols used in the production of the isocyanate-terminated PUR prepolymers are poly(oxyethylene)ether diols with equivalent weights from about 500 to about 25,000. In another embodiment of the present invention, the polyols used in the production of the isocyanate-terminated PUR prepolymers are poly(oxypropylene)ether diols with equivalent weights from about 1,000 to about 20,000. Mixtures of polyols of various structures, molecular weights and/or functionalities can also be used.

The polyether polyols can have a functionality up to about 8 but advantageously have a functionality of from 2 to 4 and more advantageously, a functionality of 2 (i.e., diols). Especially suitable are the polyether polyols prepared in the presence of double-metal cyanide (DMC) catalysts, an alkaline metal hydroxide catalyst, or an alkaline metal alkoxide catalyst; see, for example, U.S. Pat. Nos. 3,829,505, 3,941,849, 4,242,490, 4,335,188, 4,687,851, 4,985,491, 5,096,993, 5,100,997, 5,106,874, 5,116,931, 5,136,010, 5,185,420 and 5,266,681, the entire contents of each of the foregoing patents are incorporated herein by reference in their entireties. In one embodiment, the polyether polyols preferably have a number average molecular weight of from about 1,000 to about 25,000, more preferably from about 2,000 to about 20,000, and even more preferably from about 4,000 to about 18,000. Examples of commercially available diols that are suitable for making the isocyanate-terminated PUR prepolymer include ARCOL R-1819 (number average molecular weight of 8,000), E-2204 (number average molecular weight of 4,000), and ARCOL E-2211 (number average molecular weight of 11,000).

Any of numerous polyisocyanates, advantageously, diisocyanates, and mixtures thereof, can be used to provide the isocyanate-terminated PUR prepolymers. In one embodiment, the polyisocyanate can be diphenylmethane diisocyanate (“MDI”), polymethylene polyphenylisocyanate (“PMIDI”), paraphenylene diisocyanate, naphthylene diisocyanate, liquid carbodiimide-modified MDI and derivatives thereof, isophorone diisocyanate, dicyclohexylmethane-4,4′-diisocyanate, toluene diisocyanate (“TDI”), particularly the 2,6-TDI isomer, as well as various other aliphatic and aromatic polyisocyanates that are well-established in the art, and combinations thereof.

Silylation reactants for reacting with the isocyanate-terminated PUR prepolymers described above include functionality that is reactive with isocyanate and at least one readily hydrolyzable and subsequently crosslinkable group, e.g., alkoxy. Particularly useful silylation reactants are the silanes of the general formula:

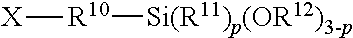

wherein X is an active hydrogen-containing group that is reactive for isocyanate, e.g., —SH or —NHR¹³ in which R¹³ is H, a monovalent hydrocarbon group of 1 to 8 carbon atoms or —R¹⁴—Si(R¹⁵)ₜ(OR¹⁶)₃₋ₜ, R¹⁰ and R¹⁴ each is the same or different divalent hydrocarbon group of up to 12 carbon atoms, optionally containing one or more heteroatoms, each R¹ and R¹⁵ is the same or different monovalent hydrocarbon group of up to 8 carbon atoms, each R¹² and R¹⁶ is the same or different alkyl group of up to 6 carbon atoms and p and t each, independently, is 0, 1 or 2. In one embodiment, p and/or t are 0, and the hydrolysable silyl group is a trialkoxy silyl group.

Examples of silanes that can be used as reactants to silylate a resin include, but are not limited to, the mercaptosilanes 2-mercaptoethyl trimethoxysilane, 3-mercaptopropyl trimethoxysilane, 2-mercaptoethyl triethoxysilane, 3-mercaptopropyl triethoxysilane, 2-mercaptoethyl tripropoxysilane, 2-mercaptoethyl tri sec-butoxysilane, 3-mercaptopropyl tri-t-butoxysilane, 3-mercaptopropyl triisopropoxysilane, 3-mercaptopropyl trioctoxysilane, 2-mercaptoethyl tri-2′-ethylhexoxysilane, 2-mercaptoethyl dimethoxy ethoxysilane, 3-mercaptopropyl methoxyethoxypropoxysilane, 3-mercaptopropyl dimethoxy methylsilane, 3-mercaptopropyl methoxy dimethylsilane, 3-mercaptopropyl ethoxy dimethylsilane, 3-mercaptopropyl diethoxy methylsilane, 3-mercaptopropyl cyclohexoxy dimethyl silane, 4-mercaptobutyl trimethoxysilane, 3-mercapto-3-methylpropyltrimethoxysilane, 3-mercapto-3-methylpropyl-tripropoxysilane, 3-mercapto-3-ethylpropyl-dimethoxy methylsilane, 3-mercapto-2-methylpropyl trimethoxysilane, 3-mercapto-2-methylpropyl dimethoxyphenylsilane, 3-mercaptocyclohexyl-trimethoxysilane, 12-mercaptododecyl trimethoxy silane, 12-mercaptododecyl-triethoxy silane, 18-mercaptooctadecyl trimethoxysilane, 18-mercaptooctadecyl methoxydimethylsilane, 2-mercapto-2-methylethyl-tripropoxysilane, 2-mercapto-2-methylethyl-trioctoxysilane, 2-mercaptophenyl trimethoxysilane, 2-mercaptophenyl triethoxysilane, 2-mercaptotolyl trimethoxysilane, 2-mercaptotolyl triethoxysilane, 1-mercaptomethyltolyl trimethoxysilane, 1-mercaptomethyltolyl triethoxysilane, 2-mercaptoethylphenyl trimethoxysilane, 2-mercaptoethyiphenyl triethoxysilane, 2-mercaptoethyltolyl trimethoxysilane, 2-mercaptoethyltolyl triethoxysilane, 3-mercaptopropylphenyl trimethoxysilane and, 3-mercaptopropylphenyl triethoxysilane, and the aminosilanes 3-aminopropyltrimethoxysilane, 3-aminopropyltriethoxysilane, 4-aminobutyltriethoxysilane, N-methyl-3-amino-2-methylpropyltrimethoxysilane, N-ethyl-3-amino-2-methylpropyltrimethoxysilane, N-ethyl-3-amino-2-methylpropyldiethoxymethylsilane, N-ethyl-3-amino-2-methylpropyltriethoxysilane, N-ethyl-3-amino-2-methylpropylmethyldimethoxysilane, N-butyl-3-amino-2-methylpropyltrimethoxysilane, 3-(N-methyl-2-amino-1-methyl-1-ethoxy)-propyltrimethoxysilane, N-ethyl-4-amino-3,3-dimethyl-butyldimethoxymethylsilane, N-ethyl-4-amino-3,3-dimethylbutyltrimethoxy-silane, N-(cyctohexyl)-3-aminopropyltrimethoxysilane, N-(2-aminoethyl)-3-aminopropyitrimethoxysilane, N-(2-aminoethyl)-3-aminopropyltriethoxy-silane, N-(2-aminoethyl)-3-aminopropylmethyldimethoxysilane, aminopropyltriethoxysilane, bis-(3-trimethoxysilyl-2-methylpropyl)amine N-(3′-trimethoxysilylpropyl)-3-amino-2-methylpropyltrimethoxysilane, isocyanate trimethoxysilane, isocyanate dimethoxysilane, isocyanate triethoxysilane, isocyanate, diethoxysilane, combinations of two or more thereof, and the like.

A catalyst will ordinarily be used to prepare the isocyanate-terminated PUR prepolymers. Condensation catalysts are generally employed to prepare the PUR. These catalysts may also catalyze the cure (hydrolysis followed by crosslinking) of the SPUR resin component of the moisture-curable composition. Suitable condensation catalysts include, but are not limited to, the dialkyltin dicarboxylates such as dibutyltin dilaurate and dibutyltin acetate, tertiary amines, the stannous salts of carboxylic acids, bismuth salts of carboxylic acids, zinc salts, organotitanium compounds, amidine compounds such as DBU, or combinations of two or more thereof, and the like. Suitable non-tin cure catalysts include, but are not limited to, organotitanium compounds such as those descried in U.S. Published Patent Application 2018/0072837, which is incorporated herein by reference in its entirety. Organotitanium compounds may be prepared by combining the desired amounts of organotitanium compound(s) and compound(s) containing a (—)₂N—C═N— linkage in a suitable solvent system, e.g., an alcohol such as methanol, ethanol, propanol, isopropanol, and the like, to form a solution, e.g., an about 40-60 weight percent solution.

The moisture-curing coating compositions may comprise the silylated resin(s) in a concentration of at least 1% by weight, at least 5% by weight, or at least 10% by weight based on the total weight of the composition. In one embodiment, the composition comprises the resin in an amount of 70% by weight or less, 60% by weight or less, 50% by weight or less, 40% by weight or less, or 30% by weight or less based on the total weight of the composition. In embodiments, the moisture-curable composition comprises the silylated resin(s) in amount of from about 1% by weight to about 70% by weight, from about 2% by weight to about 65% by weight, from about 3% by weight to about 60% by weight, from about 4% by weight to about 50% by weight, from about 5% to about 40% by weight, or from about 10% by weight to about 30% by weight based on the total weight of the composition.

The present curable compositions comprise a reactive diluent, which may also be referred to herein as a reactive modifier. The terms “reactive diluent” and/or “reactive modifier” refer to a compound containing a hydrolysable silyl group that, when combined with a moisture curable polymer (resin) having at least one hydrolysable silyl group, lowers the viscosity of the coating composition. Additionally, the present reactive diluents increase the hydrophobicity of the cured coating.

The reactive diluent comprises an alkyl alkoxysilane comprising a long chain alkyl group or heterocarbon group and a long chain alkoxy group. In embodiments, the reactive diluent is selected from a silane comprising (i) a hydrocarbon of 8 or more carbon atoms, and/or an heterocarbon group containing 8 or more carbon atoms, and (ii) alkoxy or aryloxy group having 8 or more carbon atoms. In embodiments, the heterocarbon group is selected from an amino ester group.

In embodiments, the reactive diluent is selected from a compound of the formula:

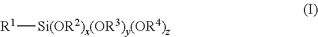

where R¹ is selected from a hydrocarbon having 8 to 40 carbon atoms or a heterocarbon group having 8 to 40 carbons and one or more hetero atoms selected from oxygen, silicon, nitrogen, and sulfur;
R² is selected from a C1 to C4 hydrocarbon;
R³ and R⁴ are each independently selected from a C8 to C40 hydrocarbon where the hydrocarbon is a linear or branched alkyl or alkenyl group, or an aromatic containing group, or a heterocarbon group having 8 to 40 carbons, wherein the heterocarbon comprises one or more hetero atoms selected from oxygen, silicon, nitrogen, and sulfur; with the proviso that when R¹ is a hydrocarbon group having 8 to 40 carbon atoms and R³ or R⁴ is a hydrocarbon then at least one of R³ or R⁴ comprises 12 or more carbon atoms;
x is 0 to less than 3;
y is 0 to 3;
z is 0 to 3;
x+y+z is 3; and
y+z is greater than 0.

In embodiments, R¹ is selected from a C8-C40 hydrocarbon, a C10-C35 hydrocarbon, a C12-C30 hydrocarbon, a C15-C250 hydrocarbon, or a C18-C20 hydrocarbon. The C8-C40 hydrocarbon may be linear, branched, comprise one or more cyclic groups, and/or comprise one or more aromatic rings. In one embodiment, R¹ is selected from a linear, branched, or cyclic containing C8-C40 alkyl, a C10-C35 alkyl, a C12-C30 alkyl, a C15-C250 alkyl, or a C18-C20 alkyl. In one embodiment, R¹ is selected from a C8-C40, C10-C35, a C12-C30, a C15-C25, or a C18-C20 aromatic-containing group. Examples of suitable hydrocarbons for R¹ include, but are not limited to, octyl, nonyl, decyl, undecyl, dodecyl, tridecyl, tetradecyl, pentadecyl, hexadecyl, heptadecyl, octadecyl, nonadecyl, eicosyl, beneicosyl, docosyl, tricosyl, tetracosyl, pentacosyl, hexacosyl, heptacosyl, octacosyl, nonacosyl, triacontyl, bentriacontyl, dotriacontyl, tritriacontyl, tetratriacontyl, pentatriacontyl, hexatriacontyl, heptatriacontyl, octatriacontyl, nonatriacontyl and tetracontyl; 1-octene, 2-methyl-1-heptene, 1-nonene, 1-decene, 1-andecene, 1-dodecene, 1-tri-decene, 1-tetradecene, 1-pentadecene, 1-hexadecene, 1-octadecene, 1-nona-decene, 1-eicosene, hexacosene, octacosene, triacontene, tetratriacontene, hexa-triacontene, octatriacontene, tetracontene, dotetracontene, tetratetracontene, hexa-tetracontenen, octatetracontene, pentacontene, dopentacontene, tetrapentacontene, hexapentacontene, octapentacontene, hexacontene, cyclooctane, cyclooctatriene, cyclododecane, norbornane, xylene, naphthalene, ethylbenzene, and the like.

In embodiments, R¹ is selected from a heterocarbon group having 8 to 40 carbon atoms that comprises one or more heteroatoms selected from oxygen, nitrogen, silicon, or sulfur. In one embodiment, R¹ is selected from an amino ester of the formula:

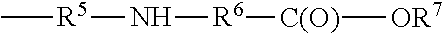

where R⁵ is a divalent C2-C8 hydrocarbon;
R⁶ is a divalent C2-C8 hydrocarbon; and
R⁷ is a monovalent C3-C25 hydrocarbon.

In one embodiment, R⁵ and R⁶ are each independently selected from a divalent C2-C8, C3-C7, or C4-C6 linear, branched, or cyclic hydrocarbon group.

In one embodiment, R⁷ is selected from a linear, branched, or cyclic-containing C3-C25 alkyl, C5-C22 alkyl, C8-C20 alkyl, a C12-C18 alkyl, or a C14-C16 alkyl.

R² is selected from a C1-C4 hydrocarbon that may be linear or branched. In embodiments, R² is selected from methyl, ethyl, propyl, isopropyl, butyl, isobutyl, or tert-butyl.

R³ and R⁴ are each independently selected from a C8 to C40 hydrocarbon and a heterocarbon having 8 to 40 carbons, wherein the heterocarbon comprises one or more hetero atoms selected from oxygen, silicon, nitrogen, and sulfur, with the proviso that when R¹ is a hydrocarbon group having 8 to 40 carbon atoms and R³ or R⁴ is a hydrocarbon then at least one of R³ or R⁴ comprises 12 or more carbon atoms.

In embodiments, when R¹ is a C8-C40 hydrocarbon, at least one of R³ and R⁴ is selected from a C12-C40 hydrocarbon, a C14-C38 hydrocarbon, a C15-C35 hydrocarbon, a C18-C32 hydrocarbon, a C20-C30 hydrocarbon, a C22-C28 hydrocarbon, or a C24-C26.

In embodiments, where R¹ is a heterocarbon group, R³ and R⁴ may be independently selected from a C8 to C40 hydrocarbon, a C10 to C38 hydrocarbon, a C12 to C35 hydrocarbon, a C14 to C32 hydrocarbon, a C15 to C30 hydrocarbon, or a C18 to C28 hydrocarbon a C20 to C26 hydrocarbon, or a C22 to C24 hydrocarbon.

The hydrocarbon for R³ and R⁴ may be linear, branched, comprise one or more cyclic groups, and/or comprise one or more aromatic rings. The linear, branched, and/or cyclic (non-aromatic) hydrocarbons may comprise one or more unsaturated carbon-carbon bonds.

In one embodiment, the hydrocarbon from which R³ and R⁴ are selected may be an aromatic-containing group, which can optionally be an aralkyl group or an alkaryl group.

Examples of suitable hydrocarbons for R³ and R⁴ include, but are not limited to, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, hentriacontyl, dotriacontyl, tritriacontyl, tetratriacontyl, pentatriacontyl, heptatriacontyl, octatriacontyl, nonatriacontyl tetracontyl; 1-octene, 2-methyl-1-heptene, 1-nonene, 1-decene, 1-andecene, 1-dodecene, 1-tri-decene, 1-tetradecene, 1-pentadecene, 1-hexadecene, 1-octadecene, 1-nona-decene, 1-eicosene, hexacosene, octacosene, triacontene, tetratriacontene, hexa-triacontene, octatriacontene, tetracontene, dotetracontene, tetratetracontene, hexa-tetracontenen, octatetracontene, pentacontene, dopentacontene, tetrapentacontene, hexapentacontene, octapentacontene, hexacontene, cyclooctane, cyclooctatriene, cyclododecane, norbornane, xylene, naphthalene, ethylbenzene, and the like.

In one embodiment, R³ and R⁴ are each selected from an alkaryl group comprising an alkyl substituent having from 1 to 30 carbon atoms where the alkyl substituent may be saturated or contain one or more points of unsaturation. In one embodiment, R³ and R⁴ are each independently selected from an alkylaryl group comprising a phenyl group having a C2-C20 alkyl substituent, a C4-C18 alkyl substituent, a C6-C15 alkyl substituent, a C8-C12 alkyl substituent, or a C9-C10 alkyl substituent, where the alkyl substituent may have zero or one or more unsaturated bonds. In one embodiment, R³ and R⁴ are each independently selected from an alkaryl group having a phenyl group with a substituent comprising a C10-C20 alkyl, a C12-C18 alkyl, or a C14-C15 alkyl having zero, one, two, or three double bonds.

In embodiments, R³ and R⁴ can be selected from an alkylaryl group derived from cardanol. In such cases, R³ and R⁴ would comprise a phenyl group having a saturated or unsaturated carbon chain of 15 carbon atoms, where the unsaturated carbon chain may comprise one, two, or three unsaturated carbon-carbon bonds in the chain. The carbon chains in the cardanol based group may be represented as follows:

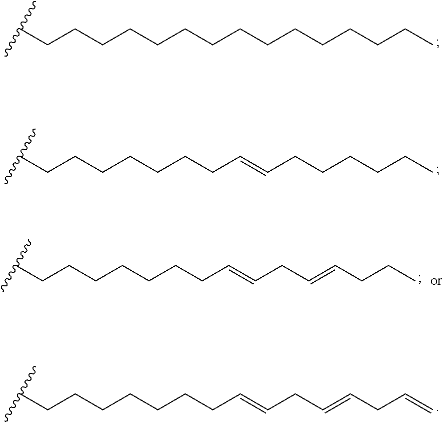 [SMILES: *CCCCCCCCCCCCCCC ; *CCCCCCC/C=C/CCCCCC ; *CCCCCCC/C=C/C/C=C/CCC ; *CCCCCCC/C=C/C/C=C/CC=C]

In some embodiments, the subscript x is 0 to less than 3. In embodiments, x is 0 to less than 3, 0.1 to 2.5, 0.1 to 2.5, 0.5 to 2.25, 0.75 to 2, 1 to 1.75, 1 to 2, 1.1 to 1.5, or 1.15 to 1.25, 1.15 to 1.75. In embodiments, x is from 1 to 2.5, 1.5 to 2.2, or 1.75 to 2. In embodiments, R² is methyl, ethyl, propyl, isopropyl, n-butyl, isobutyl, and tertbutyl.

In an embodiment x is 1 to 2 and R² is methyl.

Subscripts y and z are independently 0 to 3 with the proviso that y+z is greater than 0. In embodiments, y and z are independently selected from 0 to 3, 0.1 to 2.9, 0.5 to 2.75, 0.75 to 2.5, 1 to 2.25, 1.15 to 2, 1.25 to 1.85, or 1.5 to 1.75. In embodiments, y and z are independently from 0.75 to 1.5, 0.9 to 1.3, or 1 to 1.2. In one embodiment y+z is 0,75, 1, 2, or 3 where R³ and R⁴ are independently selected from C12-C40 alkyl groups or C12-C40 alkylaryl group.

In one embodiment, z is 0, and y is 0.1 to 2.9, 0.5 to 2.75, 0.75 to 2.5, 1 to 2.25, 1.15 to 2, 1.25 to 1.85, or 1.5 to 1.75, and x is such that x+z is 3.

In one embodiment, z is 0, and y is 0.1 to 2.9, 0.5 to 2.75, 0.75 to 2.5, 1 to 2.25, 1.15 to 2, 1.25 to 1.85, or 1.5 to 1.75, where R³ is selected from C12-C40 alkyl groups or C12-C40 alkylaryl group, and x is such that x+y is 3.

In one embodiment, z is 0, and y is 0.75, 1, 1,15, or 2, and R³ and R⁴ are selected from C12-C20 alkyl groups or C12-C20 alkylaryl group.

In one embodiment, x is 0, 1, 1.85, 2.25, or 2.5, z is 0, and y is 0.75, 1, 1,15, 2, or 3, such that x+y is 3, where R² is methyl, ethyl, propyl, or n-butyl, preferably methyl, and R³ is selected from C12-C20 alkyl groups or C12-C22 alkylaryl group, more preferably C14-C20 alkyl groups or C14-C22 alkylaryl group.

In one embodiment, R¹ is a C8-C40 alkyl; z is 0; R² is a C1-C4 alkyl; R³ is a C12-C40 alkyl, a C14-C35 alkyl, a C16-C30 alkyl, a C18-C25 alkyl, or a C20-C22 alkyl; x is 0 to 3, 0.75 to 2.25, 1 to 2, or 1.15 to 1.85; y is greater than 0 to 3, 0.75 to 2.25, 1 to 2, or 1.15 to 1.85; and x+y is equal to 3.

In one embodiment, R¹ is a C8-C16 alkyl; z is 0; R² is a C1 alkyl; R³ is a C12-C20; x is 0 to 3, 0.75 to 2.25, 1 to 2, or 1.15 to 1.85; y is greater than 0 to 3, 0.75 to 2.25, 1 to 2, or 1.15 to 1.85; and x+y is equal to 3.

In one embodiment, R¹ is a C8-C16 alkyl; z is 0; R² is a C1 alkyl; R³ is a C12-C30 alkyl; x is 0 to 3, 0.75 to 2.25, 1 to 2, or 1.15 to 1.85; y is greater than 0 to 3, 0.75 to 2.25, 1 to 2, or 1.15 to 1.85; and x+y is equal to 3.

In one embodiment, R¹ is a C8-C40 alkyl; z is 0; R² is a C1-C4 alkyl; R³ is a C12-C40 alkylaryl, a C14-C35 alkylaryl, a C16-C30 alkylaryl, a C18-C25 alkylaryl, or a C20-C22 alkylaryl; x is 0 to 3, 0.75 to 2.25, 1 to 2, or 1.15 to 1.85; y is greater than 0 to 3, 0.75 to 2.25, 1 to 2, or 1.15 to 1.85; and x+y is equal to 3.

In one embodiment, R¹ is a C8-C16 alkyl; z is 0; R² is a C1 alkyl; R³ is a C12-C22 alkylaryl; x is 0 to 3, 0.75 to 2.25, 1 to 2, or 1.15 to 1.85; y is greater than 0 to 3, 0.75 to 2.25, 1 to 2, or 1.15 to 1.85; and x+y is equal to 3.

In one embodiment, R¹ is a —R⁵—NH—R⁶—C(O)—OR⁷, where R⁵, R⁶, R⁷ are as described herein; z is 0; R² is a C1-C4 alkyl; R³ is a C8-C40 alkyl, a C12-C35 alkyl, a C14-C30 alkyl, a C16-C25 alkyl, or a C18-C22 alkyl; x is 0 to 3, 0.75 to 2.25, 1 to 2, or 1.15 to 1.85; y is greater than 0 to 3, 0.75 to 2.25, 1 to 2, or 1.15 to 1.85; and x+y is equal to 3.

In one embodiment, In one embodiment, R¹ is a —R⁵—NH—R⁶—C(O)—OR⁷, where R⁵, R⁶, R⁷ are as described herein; z is 0; R² is a C1 alkyl; R³ is a C8-C30 alkyl; x is 0 to 3, 0.75 to 2.25, 1 to 2, or 1.15 to 1.85; y is greater than 0 to 3, 0.75 to 2.25, 1 to 2, or 1.15 to 1.85; and x+y is equal to 3.

In one embodiment, In one embodiment, R¹ is a —R⁵—NH—R⁶—C(O)—OR⁷, where R⁵, R⁶, R⁷ are as described herein; z is 0; R² is a C1-C4 alkyl; R³ is a C8-C40 alkylaryl, a C12-C35 alkylaryl, a C14-C30 alkylaryl, a C16-C25 alkylaryl, or a C18-C22 alkylaryl; x is 0 to 3, 0.75 to 2.25, 1 to 2, or 1.15 to 1.85; y is greater than 0 to 3, 0.75 to 2.25, 1 to 2, or 1.15 to 1.85; and x+y is equal to 3.

In one embodiment, In one embodiment, R¹ is a —R⁵—NH—R⁶—C(O)—OR⁷, where R⁵, R⁶, R⁷ are as described herein; z is 0; R² is a C1 alkyl; R³ is a C10-C22 alkylaryl; x is 0 to 3, 0.75 to 2.25, 1 to 2, or 1.15 to 1.85; y is greater than 0 to 3, 0.75 to 2.25, 1 to 2, or 1.15 to 1.85; and x+y is equal to 3.

The reactive diluent may be present in an amount of from about 1 wt. % to about 25 wt. %, from about 2 wt. % to about 20 wt. %, from about 4 wt. % to about 15 wt. % from about 6 wt. % to about 12 wt. %, or from about 8 wt. % to about 10 wt. % based on the total weight of the composition. In embodiments, the moisture-curable coating compositions preferably comprise at least 5 PHR, at least 10 PHR, or at least 30 PHR of the reactive diluent, and in embodiments not more than 150 PHR, or not more than 100 PHR of reactive diluent. In embodiments, the moisture-curable composition comprises the reactive diluent in an amount of from about 5 PHR to about 150 PHR, from about 10 PHR to about 125 PHR, from about 30 PHR to about 100 PHR, or from about 50 PHR to about 75 PHR.

The reactive diluent silane of the moisture cure composition may be prepared by transesterification reaction comprising: (a) combining a transesterification catalyst and transesterifiable alkoxysilane to provide a mixture thereof, (b) subjecting the mixture from step (a) to transesterification reaction conditions upon addition of transesterifying alcohol thereto; (c) adding transesterifying alcohol to the mixture of step a before and/or during step (b) to provide a transesterification reaction medium thereby commencing transesterification and producing upon such alkoxysilane transesterification reaction product; (d) deactivating the transesterification catalyst from the transesterification reaction medium to provide a catalyst-depleted transesterification reaction medium containing alkoxysilane transesterification reaction product; and, optionally, (e) removing byproduct alcohol formed during transesterification from the transesterfication reaction medium; (f) separating alkoxysilane transesterification reaction product from the transesterification catalyst-depleted transesterification reaction medium of step (d).

The transesterifiable alkoxysilane in embodiments is selected from an organic functional silane having the lower carbon alkoxy groups. Thus, in embodiments, the transesterifiable alkoxysilane is an organic functional trimethoxy silane, organic functional triethoxy silane, organic functional dimethoxyethoxy silane, or organic functional diethyoxymethoxy silane. In one embodiment, the transesterifiable alkoxysilane is selected from in embodiments is selected from an alkyl functional silane or an alkyl amino ester silane having the lower carbon alkoxy groups. Thus, in embodiments, the transesterifiable alkoxysilane is an alkyl functional trimethoxy silane, alkyl functional triethoxy silane, alkyl functional dimethoxyethoxy silane, or alkyl functional diethyoxymethoxy silane, alkyl amino ester trimethoxy silane, alkyl amino ester triethoxysilane.

The transesterifying alcohol, in embodiments, is selected from a higher hydrocarbon alcohol, e.g., an alcohol comprising 8 or more carbon atoms. The transesterifying alcohol can be selected as desired to provide desired higher carbon alkoxy groups. Examples of suitable transesterifying alcohols include, but are not limited to, octanol, decanol, dodecanol, tetradecanol, hexadecanol, octadecanol, cardanol, other substituted phenol ring with long carbon chains, branched alcohol etc.

In one embodiment, the transesterifying agent is cardanol. Cardanol is a chemical derived by decarboxylation of anacardic acid which is the primary component of Cashew nut shell liquid. Cashew nut shell liquid is one of the most widely used bio-based resource to provide useful chemicals for coatings, adhesives, sealants and elastomers applications. Cardanol is a meta substituted phenol ring with mono-, di-, tri-unsaturated and saturated long 15 carbon chains, as shown, for example:

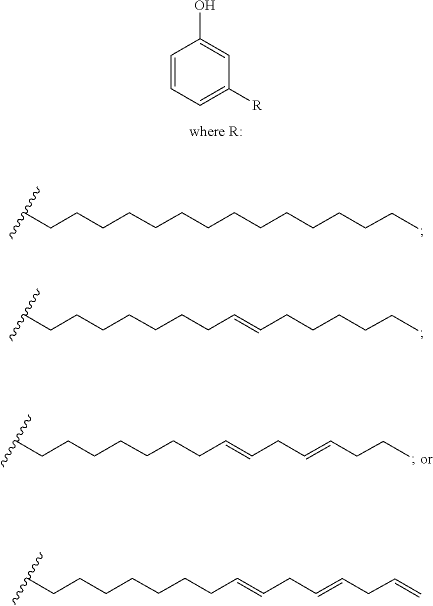

The structure of cardanol is unique as it has an aromatic ring at one end, which provides excellent rigidity, and the long chain at the meta position, which provides a good moisture barrier.

Examples of branched alcohols that may be used as the transesterifying agent include, but are not limited to, tridecyl alcohol, Exxal™ alcohols from Exxon. Exxal™ alcohols are isomeric branched, primary alcohols that contain both even- and odd-numbered hydrocarbon chains, ranging from C8 to C13.

Examples of suitable transesterification catalysts include acids, base, organometallic catalysts. Some examples of acid catalysts include, but are not limited to, sulfuric acid and p-toluenesulfonic acid. Some examples of base catalysts include, but are not limited to, sodium methoxide, sodium ethoxide. Other suitable catalysts include, but are not limited to, titanium isopropoxide, diazabicyclo(5.4.0)undec-7-ene (DBU).

As described above, the preparation of the trans-esterified silanes can be achieved from the combination of many different useful parameters such as (a) metal/non metallic catalyst, (b) alcohol type-branched/linear etc., (c) process type: batch, semi-batch or continuous addition of IPA, (d) with/without catalyst deactivation, (e) with/without removing alcohol byproduct(s), (f) with/without product purification, and (g) optional choice of removing the starting materials etc.

The moisture-curable composition further comprises a catalyst for promoting the reaction of the hydrolysable polymer resin and the reactive diluent. The catalyst can be selected from any catalyst that is effective in promoting the reaction between moisture-curable polymer and the reactive diluent, which occurs upon exposure to moisture. Suitable catalysts include but are not limited to organometallic catalysts, amine catalysts, and the like. Preferably, the catalyst is selected from the group consisting of organic tin compounds, zirconium complex, aluminum chelate, titanic chelate, organic zinc, organic cobalt, organic iron, organic nickel and organobismuth, organic potassium complex and mixtures thereof. Amine catalysts are selected from the group consisting of primary amine, secondary amine, tertiary amine and aminosilane and mixtures thereof. The catalyst can be a mixture of organometallic catalyst and amine catalyst.

Representative examples of catalysts include, but are not limited to, dibutyltin oxide, dibutyltin dilaurate, dioctyltin dilaurate, dibutyltin diacetate, stannous octoate, stannous acetate, stannous oxide, morpholine, 3-aminopropyltrimethoxysilane, 2-(aminoethyl)-3-aminopropyltrimethoxysilane, tri-isopropylamine, bis-(2-dimethylaminoethyl)ether and piperazine. Other useful catalysts include zirconium-containing, aluminum-containing, zinc complex and bismuth-containing complexes such as K-KAT™ XC6212, K-KAT™ 5218 and K-KAT™ 348, K-KAT 670 supplied by King Industries, Inc., titanium chelates such as the TYZOR® types, available from Dorf Ketal, the KR™ types, available from Kenrich Petrochemical, Inc., amines such as NIAX™ A-99 amine, available from Momentive Performance Materials, Inc., and the like.

The catalyst may be present in the moisture-curable composition in an amount of from about 0.01 weight percent to about 5 weight percent based on the total weight of components of the composition, in an amount of from about 0.1 weight percent to about 3 weight percent based on the total weight of components the composition, or in an amount of from about 0.5 weight percent to about 2 weight percent based on the total weight of the composition. The moisture cure compositions comprise at least 0.01 PHR of catalyst, 0.1 PHR of catalyst, or even 0.2 PHR catalyst.

Depending on the application and intended use of the composition, the moisture-curable composition may optionally contain other components and additives, such as, for example, pigments, fillers, curing catalysts, dyes, plasticizers, thickeners, coupling agents, extenders, volatile organic solvents, wetting agents, tackifiers, crosslinking agents, thermoplastic polymers, thixotropic agents and UV stabilizers. The additives may be used in any suitable quantities familiar to a skilled person in the field as may be useful for a particular purpose or intended application.

The filler may be selected as desired for a particular purpose or intended application. Examples of fillers suitable for the present moisture-curable resin compositions include, but are not limited to, for example, ground, precipitated and colloidal calcium carbonates which is treated with compounds such as stearate or stearic acid, reinforcing silicas such as fumed silicas, precipitated silicas, silica gels and hydrophobized silicas and silica gels; crushed and ground quartz, alumina, aluminum hydroxide, magnesium trihydrate, aluminum trihydrate, zinc, titanium oxide, ground marble, titanium hydroxide, diatomaceous earth, iron oxide, carbon black and graphite or clays such as kaolin, bentonite or montmorillonite, talc, mica, recycled natural materials such as cork particles, recycled tire rubber particles, wood particles, cellulose particles, and the like. In one embodiment of the invention, the amount of filler is from 0.1 weight percent to about 90 weight percent of the total composition. In yet another embodiment of the invention, the amount of filler is from about 5 weight percent to about 80 weight percent of the total composition. In still another embodiment of the invention, the amount of filler is from about 10 weight percent to about 40 weight percent of the total composition. The filler may be a single species or a mixture of two or more species.

In exemplary embodiments, the filler is selected from aluminum trihydrate and/or magnesium trihydrate. Another exemplary filler is silica. The moisture-curable composition can comprise silica in amounts of at least 0.1% by weight, at least 0.4% by weight, at least 0.8% by weight, at least 1% by weight, at least 2% by weight, at least 5% by weight, even at least 10% by weight. In embodiments, the composition can comprise silica in an amount of from about 0.1% by weight to about 20% by weight, from about 0.5% by weight to about 18% by weight, from about 1% by weight to about 15% by weight, from about 2% by weight to about 12% by weight, from about 5% by weight to about 10% by weight, or from about 6% by weight to about 8% by weight.

In embodiments, the moisture-curable coating composition comprises the filler in an amount of at least about 5 PHR, at least about 25 PHR, at least about 50 PHR, at least about 100 PHR, even at least about 200 PHR, and in embodiments the filler is present in an amount of not more than about 2000 PHR. In embodiments, the moisture-curable composition comprises the filler in an amount of from about 5 PHR to about 2000 PHR, from about 25 PHR to about 1500 PHR, from about 50 PHR to about 1000 PHR, from about 100 PHR to about 750 PHR, or from about 200 PHR to about 500 PHR.

In one embodiment, the composition may further include an adhesion promoter. Examples of suitable adhesion promoters include, but are not limited to, alkoxysilane adhesion promoters such as amine functional alkoxy silanes. In one embodiment, the adhesion promoter may be a combination blend of N-2-aminoethyl-3-aminopropyltrimethoxysilane and 1,3,5-tris(trimethoxysilylpropyl)isocyanurate. Other adhesion promoters useful in the present invention include but are not limited to N-2-aminoethyl-3-aminopropyltriethoxysilane, γ-aminopropyltriethoxysilane, γ-aminopropyltrimethoxysilane, bis-(γ-trimethoxysilypropyl)amine, N-Phenyl-γ-aminopropyltrimethoxysilane, γ-aminopropylmethyldimethoxysilane, γ-aminopropylmethyldiethoxysilane, methacryloxypropyltrimethoxysilane, methylaminopropyltrimethoxysilane, γ-glycidoxypropylethyldimethoxysilane, γ-glycidoxypropyltrimethoxysilane, γ-glycidoxypropyldiethoxysilane γ-glycidoxyethyltrimethoxysilane, β-(3,4-epoxycyclohexyl)propyltrimethoxysilane, β-(3,4-epoxycyclohexyl)ethylmethyldimethoxysilane, isocyanatopropyltriethoxysilane, isocyanatopropylmethyldimethoxysilane, β-cyanoethyltrimethoxysilane, β-cyanopropyltrimethoxysilane β-cyanoethyltriethoxysilane, β-cyanopropyltriethoxysilane, γ-acryloxypropyltrimethoxysilane, γ-methacryloxypropylmethyldimethoxysilane, 4-amino-3,3,-dimethylbutyltrimethoxysilane, and n-ethyl-3-trimethoxysilyl-2-methylpropanamine, oligomers of silanes and the like.

The adhesion promoter can be added to the composition in ranges of from about 0.1 weight percent to about 20 weight percent. In one embodiment of the invention, the adhesion promoter is present in an amount from about 0.3 weight percent to about 10 weight percent of the total composition. In another embodiment of the invention, the adhesion promoter is present in an amount from about 0.5 weight percent to about 2 weight percent of the total composition.

Plasticizers customarily employed in the moisture-curable resin composition can also be used in the invention to modify the properties and to facilitate use of higher filler levels. Exemplary plasticizers include, but are not limited to, phthalates, diproplyene and diethylene glycol dibenzoates, alkylsulphonate phenols, alkyl phenathrenes, alkyl/diaryl phosphates and mixtures thereof and the like. The moisture-curable composition may comprise up to 50 parts by weight, up to 25 parts by weight, up to 10 parts by weight of one or more plasticizers based on the weight of the composition. In embodiments, the moisture-curable composition comprises from about 1 to about 50 parts by weight, from about 2.5 to about 25 parts by weight, or from about 5 to about 10 parts by weight of one or more plasticizers based on the total weight of the composition. In embodiments, the moisture-curable composition comprises one or more nonreactive plasticizers such as, but not limited to, phthalic esters (e.g., dioctyl phthalate, diisooctyl phthalate, diundecyl phthalate, etc.), perhydrogenated phthalic esters (e.g., diisononyl 1,2-cyclohexanedicarboxylate, dioctyl 1,2-cyclohexanedicarboxylate, etc.), adipic esters (e.g., dioctyl adipate, etc.), benzoic esters, glycol esters, esters of saturated alkanediols (e.g., 2,2,4-trimethyl-1,3-pentanediol monoisobutyrates, 2,2,4-trimethyl-1,3-pentanediol diisobutyrates), phosphoric esters, sulfonic esters, polyesters, polyethers (e.g. polyethylene glycols, polypropylene glycols, etc.), polystyrenes, polybutadienes, polyisobutylenes, paraffinic hydrocarbons, and branched hydrocarbons of high molecular weight. The total amount of all plasticizers present in the composition is preferably not more than about 30% by weight, not more than about 20% by weight, or not more than about 10% by weight based on the weight of the composition. In embodiments, the ratio of non-reactive diluent to reactive diluent is from about 0.1 to about 10, about 0.25 to about 5, or from about 0.5 to about 2.

The composition may further include (non-silylated) silicone polymers, such as silicone resins, functionalized silicones such as phenyl silicones, epoxide-functional silicones, aminosilicones, silicone polyethers copolymers, hydroxyl functionalized silicones, organo modified trisiloxanes. In embodiments, the silicone polymer has a viscosity (measured at 25° C. using a Brookfield viscometer) of from about 5 centistokes to about 20000 centistokes, from about 100 centistokes to about 5000 centistokes, or from about 200 centistokes to about 1000 centistokes. In embodiments, the silicone polymer is selected from an epoxy-modified polydimethyl siloxane. An example of a suitable epoxy-modified polydimethylsiloxane includes, but is not limited to, SILFORCE™ UV9300 available from Momentive Performance Materials, Inc. The total amount of silicone polymers in the composition is preferably not more than about 20% by weight, more preferably not more than about 10% by weight, and most preferably not more than about 5% by weight of the composition. In embodiments the silicone polymer may be present in an amount of from about 0.1% by weight to about 20% by weight, from about 0.5% by weight to about 15% by weight, from about 1% by weight to about 12% by weight, from about 2% by weight to about 10% by weight, from about 3% by weight to about 5% by weight of the composition.

Silicone resins comprise D, T, and Q units. Silicone resins can contain a unit such as that described below:

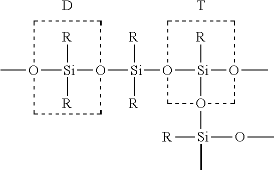

where the R group can be independently chosen from, for example, a methyl, phenyl, methoxy, ethoxy, an amine containing group, or an epoxy containing group.

The moisture-curable resin composition can optionally include various thixotropic or anti-sagging agents. Various castor waxes, fumed silica, treated clays and polyamides typify this class of additives. Stabilizers can optionally be incorporated into the moisture-curable resin composition of this invention include, for example, hindered amine and dialkylhydroxyamine.

The composition may also include a moisture scavenger. Examples of moisture scavengers include, but are not limited to, silanes such as vinyltrimethoxysilane, vinyltriethoxysilane, vinyl-methyldimethoxysilane, propyl trimethoxysilane, phenyl trimethoxysilane, O-methylcarbamatomethylmethyl-dimethoxysilane, O-methylcarbamatomethyltrimethoxysilane, O-ethylcarbamatomethylmethyldiethoxysilane, O-ethylcarbamatomethyltriethoxysilane, 3-methacryloyloxy-propyltrimethoxysilane, methacryloyloxymethyltri-methoxysilane, methacryloyloxymethylmethyldimethoxysilane, methacryloyloxymethyltriethoxysilane, methacryloyloxymethylmethyldiethoxysilane, 3-acryloyl-oxypropyltrimethoxysilane, acryloyloxymethyltrimethoxysilane, acryloyloxymethylmethyldimethoxysilanes, acryloyloxymethyltriethoxysilane, acryloyloxymethyl-methyldiethoxysilane, aminosilanes, ortho esters, such as 1,1,1-trimethoxyethane, 1,1,1-triethoxyethane, trimethoxymethane, triethoxymethane, cyanoethyl trimethoxysilane, cyanopropyl trimethoxysilane, cyanoethyltriethoxysilane, cyanopropyltrimethoxy silane, oligomers of vinyl silanes and the like. An example of a suitable moisture scavenger is, but is not limited to, the glycolic vinyl silane Silquest Y-15866 silane. It will be appreciated that the aminosilane suitable as the moisture scavenger may include the aminosilanes already described as the adhesion promoter.

The present compositions are suitable as a coating composition to form a cured coating on a surface of a target substrate. The cured composition may be employed as a sealant, primer, adhesive, and the like. The coating compositions of the invention are suitable for sealing built structures and for adhering to all typical building and/or roofing materials, such as for example concrete, wood, plastics, metals, woven glass fiber materials and roofing membranes roofing felts, roof insulating foam boards, woven fiber fabrics, modified bitumen roof membranes, acrylic roof coatings, silicone roof coatings, hybrid resin roof coatings, polyurethane roof coatings. The coating compositions of the invention are suitable for sealants for exterior building surfaces and interior building surfaces and may be applied both to horizontal and vertical surfaces. The coating composition may be formed by mixing the respective components. The coating compositions may be applied to a surface in any suitable manner including, but not limited to, brushing, roller, doctor, spraying, and the like.

The compositions are cured to form a coating by applying the composition to a surface and curing upon exposure to moisture. As used herein, the term “water” includes atmospheric moisture, steam, liquid water, ice or water mixed with other organic compounds, such as organic solvents and is preferably atmospheric moisture. The effective amount of water is that amount sufficient to react with the hydrolysable silyl groups and effect the cure of the composition. It will be appreciated that the composition can be provided as a two-part composition in which one of the parts includes water as a component. The water is generally included in one of the parts (provided that part does not include a mixture of components that would pre-maturely cure in the presence of water). Curing can take place at a temperature of from about −20° C. to about 50° C., from about −5° C. to about 40° C., from about 0° C. to about 30° C., or from about 10° C. to about 25° C.

Cured compositions may exhibit excellent mechanical properties including, for example, tensile strength, elongation, and modulus. In embodiments, a cured material formed from a composition in accordance with aspects and embodiments of the present technology may have an elongation of greater than 90%, greater than 100%, greater than 110%, greater than 120%, greater than 150%, greater than 175%, greater than 200%, greater than 225%, or even greater than 250%. In embodiments a cured material formed from a composition in accordance with aspects and embodiments of the present technology may have an elongation of from about 90% to about 300%, from about 100% to about 275%, from about 110% to about 250%, from about 120% to about 225%, from about 150% to about 210%, or from about 175% to about 250%.

The present technology has been described in the foregoing detailed description and with reference to various aspects and embodiments. The technology may be further understood with reference to the following Examples. The Examples are intended to further illustrate aspects and embodiments of the present technology and not necessarily to be limited to such aspects or embodiments.

### Examples

### Synthesis Procedure for Mixed Alkoxy Octyl-Silane/C₈H₁₇—Si(OMe)_{˜1.85}(OC₁₂H₂₅)_{˜1.15}(S-1)

Into a 3-neck 2-L round bottom flask was charged octyltrimethoxysilane (OCTMO, 357.5 grams, 1.53 mol), 1-dodecanol (326.8 grams, 1.75 mol, 1.15 eq. relative to OCTMO), and NaOMe solution (30 wt % in MeOH, 68.4 mg of solution, 100 ppm solution relative to the sum of 2 raw materials, containing ˜0.38 mmol of NaOMe). The reaction mixture was then agitated, heated to ˜50° C., and stripped under reduced pressure (100 mm Hg) for 2 hours. GC indicated the complete consumption of 1-dodecanol. Concentrated sulfuric acid (˜19 mg, ˜0.19 mmol) was added to neutralize NaOMe. The reaction mixture was further stripped at elevated temperatures and under vacuum to remove volatiles. The product in the flask was obtained as a slightly yellow liquid (625 grams yielded vs. 628 grams theoretical). The volatiles collected in the receiver was weighed as 54 grams (vs. 56 grams theoretical).

### Synthesis Procedure for H₂N—CH₂CH₂CH₂Si(OMe)₂(OC₁₂H₂₅) (S-2)

3-Aminopropyl-trimethoxysialne/H₂N—CH₂CH₂CH₂Si(OMe)₃ (Momentive A-1110, 53.8 g, 30 mmol) was charged into a 250-mL reaction flask. 1-Dodecanol (55.9 g, 30 mmol) was added with agitation at room temperature. The reaction mixture was agitated at 60° C. under vacuum (50 mm Hg) for 6 hours to remove methanol generated in situ. The liquid material in the flask was packaged as S-2. This silane is used to prepare silane S-4 described in detail below.

### Synthesis Procedure for Mixed Cardanol Functionalized Octyl-Silane/C₈H₁₇—Si(OMe)₂(OC₂₁H₂₉) (S-3)

A silane is prepared according to the following reaction:

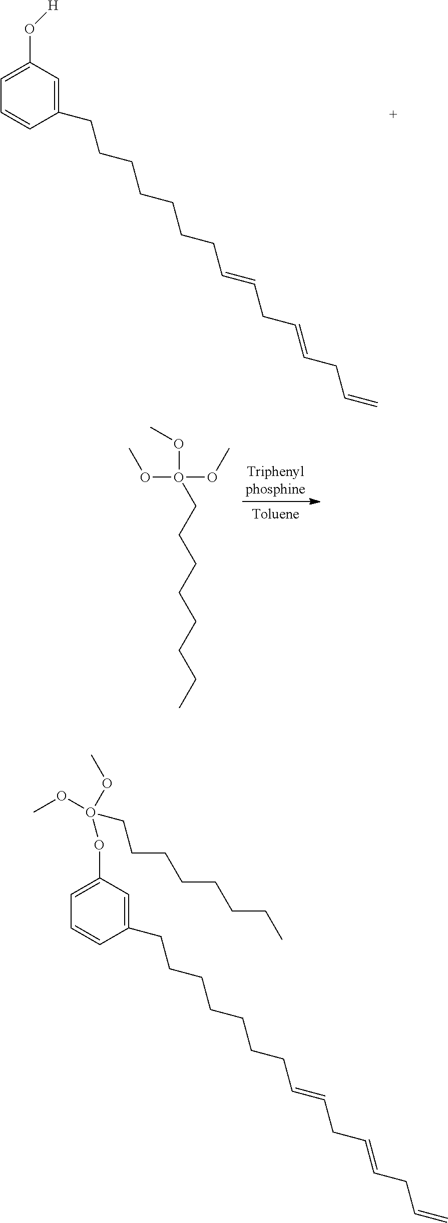

Into a 3-neck 100 mL round bottom flask was charged toluene (10 mL), cardanol (5 g, 16.8 mmol), Trimethoxy(octyl)silane(3.93 g, 16.8 mmol), to which was added triphenylphosphine (1000 ppm relative to the sum of 2 raw materials) under nitrogen atmosphere. The reaction mixture was agitated under nitrogen at refluxing conditions for 22 hours. Volatiles were then removed from the reaction mixture at 80° C. and vacuum of <5 mbar for 2 h. Around 10 mL hexane was added to the reaction mixture and washed with 20 mL MeOH twice. Volatiles were removed at 45° C. and vacuum <5 mbar for 1 h to get the final material.

### Synthesis Procedure for

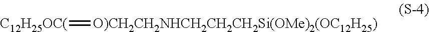

H₂N—CH₂CH₂CH₂Si(OMe)₂(OC₁₂H₂₅) (S-2, 287.0 grams, 500 mmol) was charged into a 250-mL 3-neck round bottom flask. The flask was equipped with thermometer, stir bar, condenser, and lined up to a Schlenk line. The flask was placed in a cold-water bath. Lauryl acrylate (1-dodecyl acrylate, liquid, 120.9 grams, 500 mmol) was slowly added to the reaction mixture with agitation. The reaction temperature was controlled under 25° C. by the water bath. After the addition, the reaction solution was agitated for 1 more hour. The completion of the reaction was confirmed by the disappearance of olefinic proton signals on the ¹H-NMR. The product was packaged as S-4.

### Synthesis Procedure for Mixed Linear Alcohol (C10) Functionalized Octyl-Silane (S-5)

Into a 3-neck 100 mL round bottom flask was charged Trimethoxy(octyl)silane (25 g, 0.106 mol) and 1-Decanol (19.4 g, 0.122 mol) and mixed, to which was added Titanium isopropoxide (0.165 g, 0.66% of Trimethoxy(octyl)silane). The reaction mixture was heated at 50° C. for 2 hours, while continuously distilling Methanol by applying vacuum ˜100 mbar. The titanium isopropoxide was neutralized by addition of water (0.35 g). The reaction mass was then heated to ˜100° C. and stripped at high vacuum <10 mbar to obtain the final material.

### Synthesis Procedure for Mixed Alkoxy Octyl-Silane/C₈H₁₇—Si(OMe)_{˜2.25}(OC₁₂H₂₅)_{˜0.75}(S-6)

Into a 3-neck 1-L round bottom flask was charged octyltrimethoxysilane (OCTMO, 352.6 grams, 1.50 mol), 1-dodecanol (210.2 grams, 1.13 mol, 0.75 eq. relative to OCTMO), and NaOMe solution (30 wt % in MeOH, 56 mg of solution, 100 ppm solution relative to the sum of 2 raw materials, containing ˜0.31 mmol of NaOMe). The reaction mixture was then agitated, heated to ˜50° C., and stripped under reduced pressure (100 mm Hg) for 2 hours. GC indicated the complete consumption of 1-dodecanol. Concentrated sulfuric acid (˜16 mg, ˜0.16 mmol) was added to neutralize NaOMe. The reaction mixture was further stripped at elevated temperatures and under vacuum to remove volatiles. The product in the flask was obtained as a slightly yellow liquid (525 grams yielded vs. 527 grams theoretical). The volatiles collected in the receiver was weighed as 35 grams (vs. 36 grams theoretical).

### Synthesis Procedure for Mixed Alkoxy Octyl-Silane/C₈H₁₇—Si(OMe)_{˜1.0}(OC₁₂H₂₅)_{˜2.0} (S-7)

Into a 3-neck 1-L round bottom flask was charged octyltrimethoxysilane (OCTMO, 234.4 grams, 1.00 mol), 1-dodecanol (373.4 grams, 2.00 mol, 2.0 eq. relative to OCTMO), and NaOMe solution (30 wt % in MeOH, 122 mg of solution, 200 ppm solution relative to the sum of 2 raw materials, containing ˜0.67 mmol of NaOMe). The reaction mixture was then agitated, heated to ˜50° C., and stripped under reduced pressure (100 mm Hg) for 2 hours and then at 80 C under 50 mm Hg for an additional hour. GC indicated the complete consumption of OCTMO and the presence of a trace amount of 1-dodecanol. Concentrated sulfuric acid (˜35 mg, ˜0.34 mmol) was added to neutralize NaOMe. The reaction mixture was further stripped at elevated temperatures and under vacuum to remove volatiles. The product in the flask was obtained as a slightly yellow liquid (542 grams yielded vs. 544 grams theoretical). The volatiles collected in the receiver was weighed as 62 grams (vs. 64 grams theoretical).

### Synthesis Procedure for Mixed Alkoxy Octyl-Silane/C₈H₁₇—Si(OMe)_{˜0}(OC₁₂H₂₅)_{˜3} (S-8)

Into a 3-neck 1-L round bottom flask, was charged octyltrimethoxysilane (OCTMO, 134.3 grams, 0.57 mol), 1-dodecanol (320.3 grams, 1.72 mol, 3.0 eq. relative to OCTMO), and NaOMe solution (30 wt % in MeOH, 91 mg of solution, 200 ppm solution relative to the sum of 2 raw materials, containing ˜0.51 mmol of NaOMe). The reaction mixture was then agitated, heated to ˜50° C., and stripped under reduced pressure (100 mm Hg) for 1 hour and then at 80° C. under 50 mm Hg for 3 additional hours. GC indicated the complete consumption of OCTMO and the presence of a small amount of 1-dodecanol. The average molecular formula was estimated to be close to C₈H₁₇—Si(OMe)_{˜0}(OC₁₂H₂₅)_{˜3}. Concentrated sulfuric acid (˜25 mg, ˜0.25 mmol) was added to neutralize NaOMe. The reaction mixture was further stripped at elevated temperatures and under vacuum to remove volatiles. The product in the flask was obtained as a slightly yellow liquid (398 grams yielded vs. 399 grams theoretical). The volatiles collected in the receiver was weighed as 49 grams (vs. 55 grams theoretical).

### Synthesis Procedure for Mixed Linear Alcohol (C14) Functionalized Octyl-Silane (S-9)

Into a 3-neck 100 mL round bottom flask was charged Trimethoxy(octyl)silane (30 g) and 1-Tetradecanol (31.55 g) and mixed. The mixture was heated to 49° C. and a solution of 30% sodium methoxide in methanol (30 ppm) was added to the flask. The reaction mixture was heated at 50° C. for 2 hours, while continuously distilling Methanol by applying vacuum. After analysis by GC-FID, concentrated sulfuric acid (1.6 uL) was added to neutralize the reaction. The reaction mass was then heated to 100° C. and stripped at high vacuum for 1 hour. The final product was filtered over a sintered crucible lined with filter paper.

### Volatile Content of the Reactive Silanes

Volatile organic content (VOC) of the reactive silanes in accordance with aspects of the present technology was evaluated and compared to four known silanes employed as reactive diluents (octyltrimethoxy silane, octaecyltrimethoxy silane, octadecylmethyldimethoxy silane, and hexadecyltrimethoxy silane).

VOC of the neat silanes were measured according to ASTM D2369. A silane specimen of 0.5 gram is weighed in an aluminum foil dish into which has been added 3 ml of toluene. Aluminum foil dishes with specimens were placed in a forced draft oven for 60 min at 110 C. After the dishes were removed from the oven and cooled, the dishes were weighed to calculate the percent volatile matter:
V %=100−[(W2−W1)/S]*100] where W1 is the weight of dish, W2 is the weight of dish after heating and S is the specimen weight.

The VOC measurements of the respective silanes are shown in Table 1

TABLE 1

| | VOC according |
|---|---|
| | to ASTM |
| Silane | D2369 (%) |
| Octyltrimethoxy silane | 100 |
| Octadecyltrimethoxy silane | 3.2 |
| Octadecylmethyldimethoxy silane | 6.7 |
| Hexadecyltrimethoxy silane | 6.8 |
| S1-silane | 16.8 |
| S4-silane | 6.1 |
| S6-silane | 27.4 |
| S7-silane | 2.5 |
| S8-silane | 4.6 |
| S3-silane | 0.6 |
| S9-silane | 14 |
| S5-silane | 17.4 |

### Coating Formulations

Coating formulations were generally prepared according to the following procedure. A silane-terminated polymer (Momentive, SPUR+1050 resin) was placed in a plastic open-top container. A reactive diluent silane shown in Table 1 and a small amount of moisture scavenger (Momentive A-171) were added to the container, and it was mixed well with a speed mixer. The amounts of materials are summarized in Table 2. The initial viscosity of the blend was measured and recorded.

The ground calcium carbonate (HipFlex GCC), aluminum trihydrate (Hydral 710), and aminosilane (Momentive A-1120J) were added step-by-step, and then it was mixed under vacuum by a speed mixer. It was then cooled to ˜30° C. Catalyst DBTDL (Fomrez SUL-4) and additional moisture scavenger vinyltrimethoxysilane (Momentive A-171) were charged, and it was mixed for 1 more min. It was cooled down to room temperature.

The above-prepared formulation was cast into a film and cured in a humidity chamber at 23° C. and 5000 humidity for 7 days. Tensile properties were tested according to ASTM D412, and hardness was tested under ASTM C661. The test results are listed in Table 2 and 3. Comparative examples (Comp 1-4) employ the conventional reactive diluents octyltrimethoxy silane, octaecyltrimethoxy silane, octadecylmethyldimethoxy silane, and hexadecyltrimethoxy silane, and Ex 1-8 employ reactive diluents in accordance with aspects of the present technology.

TABLE 2

| | Comp | Comp | Comp | Comp | | | | | |
|---|---|---|---|---|---|---|---|---|---|
| | 1 | 2 | 3 | 4 | Ex 1 | Ex 2 | Ex 3 | Ex 4 | Ex 5 |
| SPUR + 1050 | 26.68 | 26.68 | 26.68 | 26.68 | 26.68 | 26.68 | 26.68 | 26.68 | 26.68 |
| Prepolymer | | | | | | | | | |
| Octyltrimethoxy silane | 8.82 | | | | | | | | |
| Octadecyltrimethoxy | | 8.82 | | | | | | | |
| silane | | | | | | | | | |
| Octadecylmethyldimethoxy | | | 8.82 | | | | | | |
| silane | | | | | | | | | |
| Hexadecyltrimethoxy | | | | 8.82 | | | | | |
| silane | | | | | | | | | |
| S1-Silane | | | | | 8.82 | | | | |
| S4-Silane | | | | | | 8.82 | | | |
| S-6 Silane | | | | | | | 8.82 | | |
| S-7 silane | | | | | | | | 8.82 | |
| S-8 silane | | | | | | | | | 8.82 |
| Ground Calcium | 41.34 | 41.34 | 41.34 | 41.34 | 41.34 | 41.34 | 41.34 | 41.34 | 41.34 |
| Carbonate | | | | | | | | | |
| Aluminum Trihydrate | 20 | 20 | 20 | 20 | 20 | 20 | 20 | 20 | 20 |
| Silquest A-171 silane | 2 | 2 | 2 | 2 | 2 | 2 | 2 | 2 | 2 |
| Silquest A-1120J silane | 1.08 | 1.08 | 1.08 | 1.08 | 1.08 | 1.08 | 1.08 | 1.08 | 1.08 |
| Dibutyl Tin Dilaurate | 0.08 | 0.08 | 0.08 | 0.08 | 0.08 | 0.08 | 0.08 | 0.08 | 0.08 |
| Total | 100 | 100 | 100 | 100 | 100 | 100 | 100 | 100 | 100 |
| Mechanical Properties | | | | | | | | | |
| Tensile Stress at Break | 288.8 | N/A | 312 | N/A | 209.4 | 251 | 265 | 124 | 129 |
| (psi) | | (Brittle) | | (Brittle) | | | | | |
| Elongation (%) | 85.8 | N/A | 56.3 | N/A | 180 | 167 | 170 | 156 | 148 |
| | | (Brittle) | | (Brittle) | | | | | |
| Modulus 50% (psi) | 291 | N/A | 311.4 | N/A | 160.2 | 175 | 208 | 80 | 73 |
| | | (Brittle) | | (Brittle) | | | | | |
| Modulus 100% (psi) | — | N/A | — | N/A | 180.2 | 225 | 233 | 102 | 113 |
| | | (Brittle) | | (Brittle) | | | | | |
| Initial Shore A | 75 | ~75 | 78 | ~75 | 58 | 63 | 56 | 51 | 53 |
| Hardness | | | | | | | | | |

As shown in Tables 1, 2, and 3 alkoxy silanes in accordance with aspects of the present technology (e.g., silanes S1, S3, S4, S5, S6, S7, S8, and S9) had a VOC of less than 30% according to ASTMD2369. Further, use of these silanes as a reactive diluent in a curable composition, such as in a silylated resin like a silylated polyurethane, provided high flexibility (maximum elongation >90%) to the waterproofing membranes prepared with silylated resin compared to alkyl trimethoxy silanes.

TABLE 3

| | Ex 6 | Ex 7 | Ex 8 |
|---|---|---|---|
| | wt % | wt % | wt % |
| SPUR + 1050 Prepolymer | 26.68 | 26.68 | 26.68 |
| S3-Silane | 8.82 | | |
| S9-silane | | 8.82 | |
| S5-silane | | | 8.82 |
| Ground calcium carbonate | 41.34 | 41.34 | 41.34 |
| Aluminum Trihydrate | 20 | 20 | 20 |
| Silquest A-1120J silane | 1.08 | 1.08 | 1.08 |
| Silquest A-171 silane | 2 | 2 | 2 |
| Dibutyl Tin Dilaurate | 0.08 | 0.08 | 0.08 |
| Total | 100 | 100 | 100 |
| Mechanical Properties | | | |
| Tensile Stress at Break (psi) | 210 | 185 | 210 |
| Maximum elongation (%) | 92 | 120 | 100 |
| Modulus 50% (psi) | 195 | 160 | 200 |
| Modulus 100% (psi) | — | 180 | 215 |

TABLE 4

| Formulation Component | Ex 9 (%) |
|---|---|
| SPUR + 1070 prepolymer | 22.5 |
| Hydroxyl terminated PDMS (500 cps) | 0.31 |
| Silforce UV9300 silicone | 0.31 |
| S1-Silane | 10.26 |
| Silquest A-171 | 1.275 |
| Silquest A-1110 | 0.94 |
| Mesomoll plasticizer | 8.5 |
| Eversorb HP1 stabilizer | 1.5 |
| HipFlex Ground Calcium Carbonate | 32.1 |
| Aluminum trihydrate (Martinal OL 104C) | 20 |
| Titanium oxide (Tronox 828E ) | 2.2 |
| TIB KAT 216 Tin catalyst | 0.1 |
| Total | 100 |
| Tensile Stress at Break (psi) | 130 |
| Elongation (%) | 222 |
| Modulus 50% (psi) | 86 |
| Modulus 100% (psi) | 117 |

° Silforce UV9300 is an epoxide-functional polydimethylsiloxane copolymer with an epoxy weight equivalent of 950 grams/mole oxirane, with a viscosity of 300 cstks at 25° C..

Clear sealant compositions were also prepared with the alkoxy silanes. The compositions are shown in Table 5 (Ex 10 and 11). The clear sealant examples (Ex 10 and Ex 11) were prepared in a Speed mixer (DAC600.2 VAC-P from FlackTek inc.). In Ex 10, SPUR+1020 prepolymer was mixed with S1-silane in a FlackTeck plastic cup with three ceramic cylinders at 2000 rpm for one minute. The fumed silica (Aerosil R812S) and the UV stabilizer were added to the mixture and then mixed for 3 consecutive cycles of one minute at 1500 rpm. Silquest ALink 600 silane was added to the mixture and mixed for 1 min at 2000 rpm with vacuum. Silquest CNM silane was added to the mixture and mixed for 1 min at 2000 rpm with vacuum. The mixture was cooled at room temperature before adding the Tin catalyst and final mixing for 45 seconds at 2000 rpm with vacuum. Ex 11 sealant was prepared with a similar process. Tensile properties of the sealant were measured using ASTM D412. The properties of the sealant are shown in Table 5.

TABLE 5

| | Ex 10 | Ex 11 |
|---|---|---|
| Components | wt % | wt % |
| SPUR + 1020 Prepolymer | 66.5 | |
| SPUR + 1050 Prepolymer | | 43.55 |
| Silane S-1 | 20 | 14.52 |
| Addworks IBC 760 (Clariant) UV | 0.8 | |
| stabilizer | | |
| Aerosil R812 S fumed silica | 7.8 | |
| Aerosil R974 | | 14.52 |
| Silquest ALink 600 aminosilane | 1.5 | |
| DIDP plasticizer | | 19.16 |
| Silquest ALink 235 aminosilane | | 8.13 |
| Silquest CNM silane | 3 | |
| Dimethyl Tin neodecanoate (reaxis) | 0.4 | 0.12 |
| Total | 100 | 100 |
| Mechanical Properties | | |
| Modulus at 50% elongation (psi) | 53 | 96 |
| Modulus at 100% elongation (psi) | 92 | 161 |
| Tensile strength (psi) | 220 | 293 |
| Elongation at break (%) | 175 | 204 |

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of an acrylate-functional silicone, a composition comprising the same, copolymers thereof, and a latex formed from the same. Modifications may occur to those skilled in the art and to those who may make and use the invention. The disclosed embodiments are merely for illustrative purposes and not intended to limit the scope of the invention or the subject matter set forth in the claims.

What is claimed is:

1. A curable composition comprising:
a silylated polymer resin;
a reactive diluent selected from a compound of the formula: 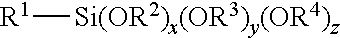
where R¹ is selected from a hydrocarbon group having 8 to 40 carbon atoms or a heterocarbon group having 8 to 40 carbon atoms;
R² is selected from a C1 to C4 hydrocarbon;
R³ and R⁴ are independently selected from a C8 to C40 hydrocarbon and a heterocarbon having 8 to 40 carbons, wherein the heterocarbon comprises one or more hetero atoms selected from oxygen, silicon, nitrogen, and sulfur; with the proviso that when R¹ is a hydrocarbon group having 8 to 40 carbon atoms and R³ or R⁴ is a hydrocarbon then at least one of R³ or R⁴ comprises 12 or more carbon atoms;
x is 0 to less than 3;
y is 0 to 3;
z is 0 to 3;
x+y+z is 3; and
y+z is greater than 0; and
a catalyst.

2. The curable composition of claim 1, wherein R¹ is a C8 to C40 hydrocarbon.

3. The curable composition of claim 1, wherein R¹ is selected from a linear, branched, or cyclic containing C8-C40 alkyl, or a C8-C40 aromatic-containing group.

4. The curable composition of claim 1, wherein R¹ is selected from the heterocarbon group having 8 to 40 carbon atoms, and the heterocarbon having 8 to 40 carbon atoms is of the formula: 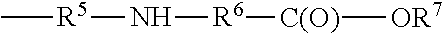
where R⁵ is a divalent C2-C8 hydrocarbon;
R⁶ is a divalent C2-C8 hydrocarbon; and
R⁷ is a monovalent C3-C25 hydrocarbon.

5. The curable composition of claim 4, wherein R⁵ and R⁶ are independently selected from a divalent C2-C8 linear, branched, or cyclic group.

6. The curable composition of claim 4, wherein R⁷ is selected from a linear, branched, or cyclic-containing C3-C25 alkyl.

7. The curable composition of claim 1, wherein R² is selected from methyl, ethyl, propyl, isopropyl, butyl, isobutyl, or tert-butyl.

8. The curable composition of claim 1, wherein R³ and R⁴ are independently selected from a linear, branched, or cyclic, substituted or unsubstituted C8-C40 alkyl or a linear, branched, or cyclic aromatic substituted C8-C40 aralkyl.

9. The curable composition of claim 8, wherein R³ and R⁴ are independently selected from a linear, branched, or cyclic C12-C40 alkyl substituted with aromatic group, wherein the C12-C40 alkyl is optionally containing alkenyl groups.

10. The curable composition of claim 9, wherein R³ and R⁴ are derived from Cardanol.

11. The curable composition of claim 1, wherein x is 0.1 to 2.5, and y and z are independently 0 to 3 with the proviso that y+z is greater than 0.

12. The curable composition of claim 11, wherein z is from 0 to 3, and y is 0.1 to 2.9.

13. The curable composition of claim 1, wherein x is 0.1 to 2.5, z is 0, and y is 0.5 to 2.9.

14. The curable composition of claim 1, wherein z is 0; R¹ is a C8-C40 alkyl; R² is a C1-C4 alkyl; R³ is a C10-C40 alkyl; x is 0 to less than 3, y is greater than 0 to 3; and x+y is equal to 3.

15. The curable composition of claim 14, wherein R² is methyl and R³ is a C12-C14 alkyl.

16. The curable composition of claim 15, wherein (i) x is 0 and y is 3, (ii) x is 0.5 and y is 2.5, (iii) x is 1 and y is 2, (iv) x is 1.85 and y is 1.15, (v) x is 2 and y is 1, or (vi) x is 2.25 and y is 0.75.

17. The curable composition of claim 1, wherein z is 0; R¹ is of the formula —R⁵—NH—R⁶—C(O)—OR⁷, where R⁵ is a divalent C2-C8 hydrocarbon, R⁶ is a divalent C2-C8 hydrocarbon, and R⁷ is a monovalent C3-C25 hydrocarbon; R² is a C1-C4 alkyl; R³ is a C8-C40 alkyl; x is 0 to less than 3, y is greater than 0 to 3; and x+y is equal to 3.

18. The curable composition of claim 17, wherein R² is methyl and R³ is a C8-C14 alkyl.

19. The curable composition of claim 18, wherein (i) x is 0.5 and y is 2.5, (ii) x is 1 and y is 2, (iii) x is 1.85 and y is 1.15, (iii) x is 2 and y is 1, or (iv) x is 2.25 and y is 0.75.

20. The curable composition of claim 1, wherein z is 0; R¹ is a C8-C40 alkyl; R² is a C1-C4 alkyl; R³ is a C12-C40 alkylaryl; x is 0 to 3, y is greater than 0 to 3; and x+y is equal to 3.

21. The curable composition of claim 20, wherein R² is methyl and R³ is a C16-C22 alkylaryl.

22. The curable composition of claim 20, wherein the alkylaryl comprises at least one unsaturated carbon-carbon bond.

23. The curable composition of claim 21, wherein (i) x is 0 and y is 3, (ii) x is 1 and y is 2, (iii) x is 1.85 and y is 1.15, (iii) x is 2 and y is 1, or (iv) x is 2.25 and y is 0.75.

24. The curable composition of claim 1, wherein the reactive diluent is present in an amount of from about 1 wt. % to about 25 wt. % based on the weight of the curable composition.

25. The curable composition of claim 1, wherein the silylated resin is selected from a silylated polyol, a silylated polyether, a silylated polyurethane resin, and a silane-containing copolymer obtained from the copolymerization of one or more ethylenically unsaturated silanes.

26. The curable composition of claim 25, wherein the silylated resin is selected from a silylated polyurethane resin.

27. The curable composition of claim 26, wherein the silylated resin comprises a hydrolysable group comprising a trialkoxy silane.

28. The curable composition of claim 1, wherein the silylated resin is present in an amount of from about 1% by weight to about 70% by weight of the composition.

29. The curable composition of claim 1, wherein the catalyst is selected from a tin catalyst.

30. The curable composition of claim 1, wherein the catalyst is present in an amount of from about 0.01 weight percent to about 5 weight percent based on the total weight of the composition.

31. The curable composition of claim 1 further comprising an adhesion promoter.

32. The curable composition of claim 31, wherein the adhesion promoter is selected from an aminosilane.

33. The curable composition of claim 31, wherein the adhesion promoter is present in an amount of from about 0.1 weight percent to about 20 weight percent based on the total weight of the composition.

34. The curable composition of claim 1, comprising a non-silylated silicone.

35. The curable composition of claim 34 where the non-silylated silicone is selected from a hydroxy functional silicone, an epoxy functional silicone, or combination thereof.

36. A cured material formed from the curable composition of claim 1.

37. A coating composition comprising the curable composition of claim 1.

38. The coating composition of claim 37, wherein the coating is a sealant, an adhesive, or a primer.

39. The cured material or coating composition of claim 36 having an elongation of about 90% or greater.

40. The cured material or coating composition of any of claim 36 having an elongation of about 90% to about 300%.

41. An article comprising a substrate and a curable composition of claim 1 disposed on a surface of the substrate.

42. The article of claim 41, wherein the substrate is selected from concrete, wood, plastic, metal, glass fiber, fiber fabric, or a mixture of two or more thereof.

43. The article of claim 41, wherein the curable composition is cured to form a coating.

44. The article of claim 41, wherein the substrate comprising the curable composition is adhered to a second substrate through the curable composition.

45. A method of forming the coating composition of claim 1 comprising mixing the silylated polymer resin, reactive diluent, and catalyst.

46. A method of forming a cured material comprising exposing the curable composition of claim 1 to moisture.
